(19) United States
(12) Patent Application Publication
(10) Pub. No.: US 2012/0128405 A1
(43) Pub. Date: May 24, 2012

(54) CONSTRUCTION PROFILES CORNER ASSEMBLING SYSTEM

(75) Inventor: Yakup YANIK, Izmir (TR)

(73) Assignee: TEKPAN TEKNIK ELEKTRIK KUMANDA PANO SANAYI VE TURIZM TICARET LIMITED SIRKETI, Izmir (TR)

(21) Appl. No.: 13/303,724

(22) Filed: Nov. 23, 2011

(30) Foreign Application Priority Data
Nov. 23, 2010 (TR) 2010/09615

(51) Int. Cl. F16B 1/00; H01R 4/00

(52) U.S. Cl. 403/42

(57) ABSTRACT

A corner assembling system includes at least one coupling indent ensuring not opening of the coupling curve, at least one exterior surface support indent providing resistance and support to the front exterior surface, and a grounding tab increasing the grounding integrity of aluminium corner assembling member. A vertical profile interior tightening and connecting piece fixes the vertical profile to the aluminium corner assembling member from inside. A horizontal profile interior tightening and connecting piece fixes the horizontal profiles to both aluminium corner assembling member and to one another from inside. The system provides for assembling of power distribution panels, boxes and rectangular frame construction profiles with one another without a welding.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a corner assembling system that provides assembling of power distribution panels, boxes and rectangular frame construction profiles with one another without welding.

2. Description of Related Art Including Information Disclosed Under 37 CFR 1.97 and 37 CFR 1.98.

Today, there are many solutions for assembling power distribution panels, boxes and rectangular frame construction profiles. These solutions have different features and models with the materials and shapes, according to their size and sensitivity. In these models, too, three different profiles are assembled without welding by means of corner assembling member. However, difficulties are experienced with the existing models during assembly. In addition, about their resistance, in terms of using the product, it leads to life shortening or permanent damages to the product.

During patent search made with regard to the prior art, the application numbered U.S. Pat. No. 6,902,068 was found. In that application, mention is made of a frame member used in power distribution panel boxes. Said frame member contains two pieces of corner assembling joints and two pcs of corner assembling members.

Another application found during patent search on the other hand is the application numbered US2003172613. That application relates to a frame member used in power distribution panel boxes.

In existing models, accomplishing the assembly takes a long time and mounting cost is increased due to the closeness of the screws to the corners in assembly of the profiles during assembly.

In existing models, after the assembly of the profiles, grounding integrity of the construction is ensured via simple part contacts, by means of contacting the two surfaces with one another. However, when the construction is required to be painted in order to increase resistance against corrosion, grounding integrity can not be ensured because dye enters between these two surfaces.

In the prior art, after the assembly of the profiles, fixing and reinforcement with the assembling corner of said profiles can be made from only one exterior (front) surface. And that causes this surface's the failing to have sufficient level of resistance against the force applied on itself, and becoming flexible. With this flexibility, the construction's profiles remain in a tilting position, failing to stand in perpendicular angle to one another at the assembling corner. Furthermore, when continuous force is exerted, the assembling corner member moves within the profiles.

To the problems occurring in the prior art, many more negative situations can be added such as failing to achieve full assembly of the covers and parts of the construction, the construction assembly of which is made to stand tilting, the profile getting deformed by the joint of the profiles when the construction is lifted up by means of a crane and occurrence of permanent deformations in profiles, flexibility causing permanent damages to the corner assembling member.

In the prior art, there does not exist a setup for connection of the profiles form three surfaces and two internal surfaces remaining idle lack being supported with the same support piece. In addition, also in models, as there are not any resistance structures on exterior front surface where the power comes at the maximum, the front surface of the profile becomes flexed.

In conclusion, because of the adversities mentioned above and due to the inadequacy of the existing solutions have necessitated to make a development in the respective related art.

### BRIEF SUMMARY OF THE INVENTION

The invention aims to solve the above said adversities, formed on inspirations by existing situations.

A purpose of the invention is to eliminate disadvantages of existing models during the process of assembling the construction and its usage.

A further purpose of the invention is to prevent outlet parts of profiles from flexing, not only from one front surface, but by means of joining assembling corner member with the parts increasing the fixing effect on three surfaces.

A further purpose of the invention is to increase resistance against flexibility in the area where the force is the most dense, via two support indents, upon prevention of the flexibility of outlet parts of the profiles with two support indents on front surface.

A further purpose of the invention is to allow for use of additional support pieces, for assembling corner has the means of internal connection. With that means, separately from the corner assembling member, the part in L shape and having dots on and the horizontal profiles prevents elasticity by also finding the means of connection with one another.

A further purpose of the invention is that the cover and other components of construction are mounted smoothly, for it prevents elasticity.

A further purpose of the invention is to ensure that much more load can be carried in carrying the constructions by crane.

A further purpose of the invention is to eliminate permanent damages that might occur during transportation of the construction.

A further purpose of the invention is to be able to ensure grounding integrity thanks to grounding tabs on the aluminium corner assembling member used for assembly of horizontal and vertical profiles.

A further purpose of the invention is to continue grounding integrity since it contacts by scratching the inner surfaces of the profiles when painted in order to increase resistance against corrosion.

A further purpose of the invention is to achieve a much more rapid assembly of the profiles and to save time due to all assembling apparatuses and screws are in an easy position for assembly.

The structural and characteristic properties and all of its advantages of the invention will be understood more clearly from the drawings provided below, and from the detailed description written by making references to these drawings and therefore the assessment should be made by taking these drawings and the detailed description into account.

### BRIEF DESCRIPTION OF THE SEVERAL VIEWS OF THE DRAWINGS

FIG. 1 is a front view of the corner assembling system in exploded state which is the subject of the invention.

FIG. 2 is a front view of the corner assembling system in an assembled state which is the subject of the invention.

FIG. 3 is a rear view of the corner assembling in an exploded state which is the subject of the invention.

FIG. 4 is a rear view of the corner assembling system in an assembled state which is the subject of the invention.

FIG. 5 is a side, cross-sectional view of the vertical profile (10) and of the horizontal profiles (20).

FIG. 6 is a front view of the aluminium corner assembling member (40).

FIG. 7 is a rear view of the aluminium corner assembling member (40).

### DESCRIPTION OF COMPONENT REFERENCES

10. Vertical profile

20. Horizontal profile

31. Rear exterior surface

32. Lower exterior surface

33. Rear interior surface

34. Lower interior surface

35. Coupling indent

36. Coupling curve

37. Front exterior surface

38. Front interior surface

39. Exterior surface support indent

40. Corner assembling member

41. Grounding tab

42. Vertical profile exterior connection surface

43 Horizontal profile exterior connection profile

44. Horizontal profile interior connection surface

45. Vertical profile interior connection profile

46. Crane shackle eyelet

50. Horizontal profile exterior tightening and connecting piece

60. Vertical profile exterior tightening and connecting piece and door hinge

70. Vertical profile interior tightening and connecting

71. Support Height

80. Horizontal profile interior tightening and connecting piece

81. Anti flex heights

90. Connectors

91. Crane shackle

The drawings need not absolutely be put to scale and the details not necessary to understand the invention may have been omitted. Furthermore, the elements that are at least substantially identical, or at least have substantially identical functions are indicated with the same number.

### DETAILED DESCRIPTION OF THE INVENTION

In this detailed description, the preferred embodiments of the construction profile corner assembling system, which is the subject of the invention, are disclosed only for better understanding of the subject, and in a manner not constituting any restrictive effect.

The invention is corner assembling system that provides assembly of power distribution panels, boxes and rectangular frame construction profiles with one another without a welding, comprising vertical profile (10) and horizontal profiles (20), coupling curve (36) created on the vertical profile (10) and horizontal profiles (20) and assembling vertical profile (10) and horizontal profiles (20) without a welding, aluminium corner assembling member (40), crane shackle eyelet (46), horizontal profile exterior tightening and connecting piece (50), vertical profile exterior tightening and connecting piece and door hinge (60)

It is characterised in that it comprises:
at least one coupling indent (35) created on rear exterior surface (31) or lower exterior surface (32) of the vertical profile (10) and of horizontal profiles (20), ensuring not opening of said coupling curve (36);
at least one exterior surface support indent (39) created on the front exterior surface (37) of the vertical profile (10) and of horizontal profiles (20), providing resistance and support to the front exterior surface (37);
grounding tab (41) created on the horizontal profile interior connection surface (44) and on the horizontal profile exterior connection surface (43) of the aluminium corner assembling member (40), increasing the grounding integrity of said aluminium corner assembling member (40);
vertical profile interior tightening and connecting piece (70) fixing the vertical profile (10) to the aluminium corner assembling member (40) from inside; and
horizontal profile interior tightening and connecting piece (80) fixing the horizontal profiles (20) to both aluminium corner assembling member (40) and to one another from inside.

The corner assembling system comprises anti-flex heights (81) preferably created on said horizontal profile interior tightening and connecting piece (80) and not allowing flexibility of the horizontal profiles (20) by engaging into the holes located on the rear exterior surface (31) of the horizontal profiles (20).

The corner assembling system is preferably characterised in that it comprises a support height (71) preventing spinning of said vertical profile interior tighening and connecting piece (70) and providing supporting of the vertical profile (10).

In the corner assembling system, preferably screws and serrated washers are used as said connectors (90).

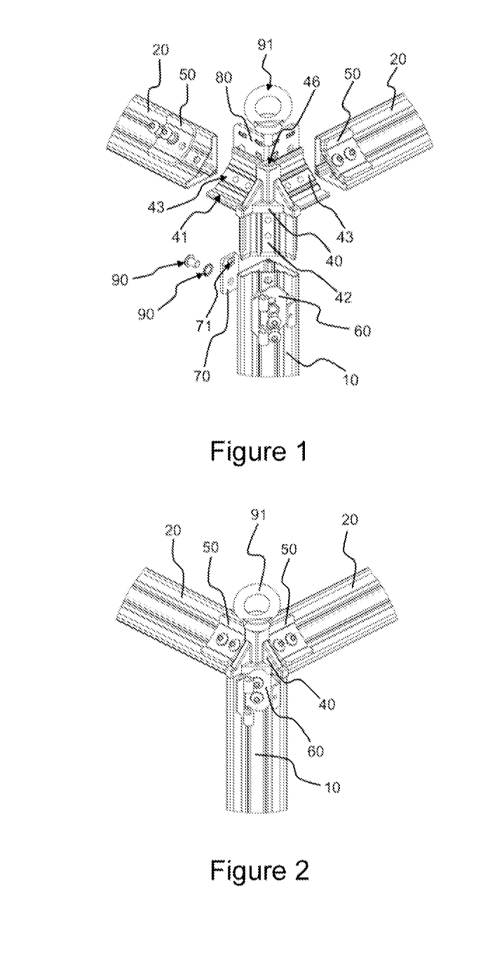

During creation of the construction, corner assembling is achieved by assembling the vertical profile (10) and two pieces of horizontal profiles (20) with the corner assembling member (40). During corner assembling, the grounding tabs (41) on the corner assembling member (40) provide grounding integrity to the construction during corner assembling process via contacting by scratching to the rear interior surface (33), to the lower interior surface (34) and to the front interior surface (38) of the vertical profile (10) and of the horizontal profiles (20) (FIG. 1).

In order to fix the horizontal profiles (20) to the aluminium corner assembling member (40), horizontal profile exterior tightening and connecting piece (50) is used (FIG. 1, FIG. 2). As a priority, the horizontal profiles (20) are passed onto horizontal sections of the corner assembling member (40), so that front interior surfaces (38) thereof come upon the horizontal profile exterior connection surface (43) of the corner assembling member (40). And thus, the rear interior surface (33) of the horizontal profile (20) comes upon profile interior connection surface (44). Subsequently, the horizontal profile exterior tightening and connecting piece (50) fixes the horizontal profiles (20) and the corner assembling member (40) to one another by being screwed to the horizontal profiles (20) by means of connectors (90). The connectors (90) are preferably M8 screws and serrated washers. The function of the serrated washer is to prevent the screws from becoming loose. In addition, the horizontal profile exterior tightening and connecting piece (50) prevents flexibility of the front exterior surface (37) of the horizontal profiles (20) by pressing on the exterior surface support indents (39) on the front exterior surface (37) of the profiles (20).

In order to fix the vertical profile (10) to the aluminium corner assembling member (40), vertical profile exterior tightening and connecting piece and door hinge (60) (FIG. 1, FIG. 2). The vertical profile exterior tightening and connecting piece and door hinge (60) are screwed to the vertical profile (10) by preferably M8 screws and washers and fix the vertical profile (10) to the corner assembling member (40). The vertical profile (10) is screwed to the aluminium corner assembling member (40), by contacting it with the exterior connection surfaces (42) of the vertical profile and is fixed. Moreover, vertical profile exterior tightening and connecting piece and door hinge (60) prevent flexibility of the front exterior surface (37) of the vertical profile (10) by pressing on the exterior surface support indents (39) on the front exterior surface (37) of the profiles (10).

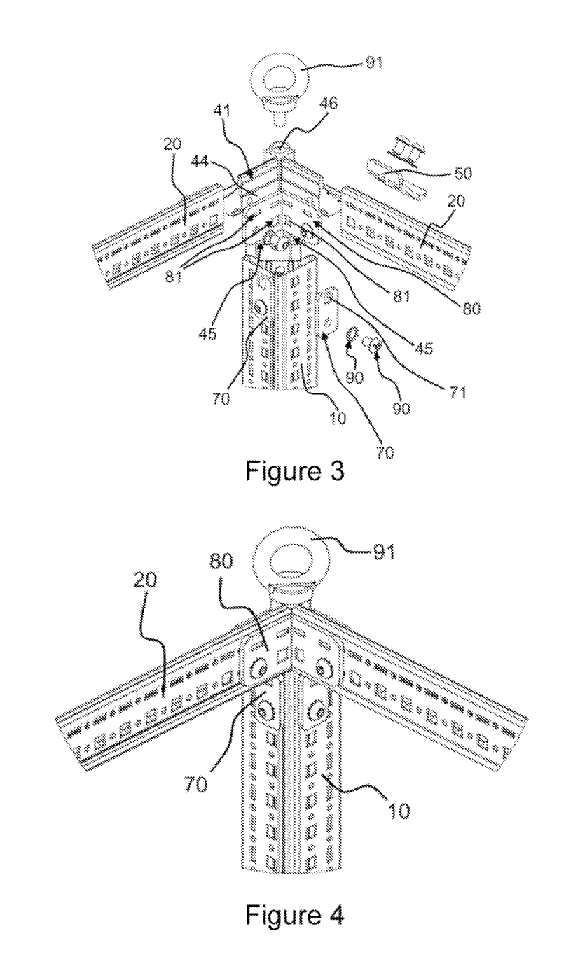

In order to reinforce connection of the vertical horizontal profiles (20) to the aluminium corner assembling member (40) and so that the horizontal profiles (20) can be fastened to one another more powerfully, horizontal profile interior tightening and connecting piece is used (80) (FIG. 3, FIG. 4). The horizontal profiles (20), as a priority, are passed onto the horizontal sections of the corner assembling member (40), so that the holes on said connecting piece (80) come upon the square holes on the horizontal profiles (20) and the anti-flex height (81) in square and rectangular relief shape on said connecting piece (80) come upon the square and rectangular holes on the horizontal profiles (20). Subsequently, fixing process is carried out by screwing through the connectors (90) that are selected preferably as M8 screws and serrated washers.

Flexibility movement of the horizontal profiles (20) is prevented through coupling of the anti-flex heights (81) in rectangular relief and square relief shape on the horizontal profile interior tighening and component connecting piece (80) into the matching holes on the rear exterior surfaces (31) of the horizontal profiles (20) (FIG. 3). Thus, horizontal profiles (20) are bonded to the aluminium corner assembling member (40) both more tightly and also they prevent breakaway of the construction in hauling by a crane by making the construction's vertical profiles (20) a single and firm structure by performing a separate assembly function on the horizontal profiles (20) as well.

In order to reinforce the connection of the vertical profile (10) to the aluminium corner assembling member (40) from inside, vertical profile interior tighening and connecting piece (70) is used (FIG. 3, FIG. 4). After the vertical profile (10) is passed onto the corner assembling member (40), said connecting piece (70) is fixed to the vertical profile (10) by means of screwing so that the support height (71) in square relief shape on said connecting piece (70) engages into the matching hole on the vertical profile (10) and the hole on said connecting piece (70) comes upon the matching hole on the vertical profile (10). Said process of screwing and fixing happens preferably by means of M8 screws and serrated washers. Better tightening is achieved through coupling of the support height (71) on the vertical profile interior tightening and connecting piece (70) on support height (71) into the matching holes on the rear exterior surface (31) and lower exterior surface (32) of the vertical profile (10) and spinning of said connecting piece (70) is prevented. Thus, the vertical profile (10) is attached to the aluminium corner assembling member (40) more tightly. Elasticity is not experienced at connection points of the vertical profile (10) connected to the aluminium corner assembling profile (40) from three different surfaces (31, 32, 37). Creation of a more dynamic and stronger structure is ensured both during the setup, transfer and transportation of the construction.

Crane shackle (91) chosen preferably as M12 type is fixed to the crane shackle eyelet (46) on the aluminium corner assembling member (40) by screwing (FIG. 1, FIG. 2). M12 crane shackles (91) located over joints of the construction's horizontal profiles (20) allow uplifting of the construction by crane. In the corner where vertical profile (10) and horizontal profiles (20) meet, the carrying of the construction, being lifted by M12 crane shackle, is ensured in a stronger and safer way thanks to the aluminium corner assembling member (40) having an all compact structure.

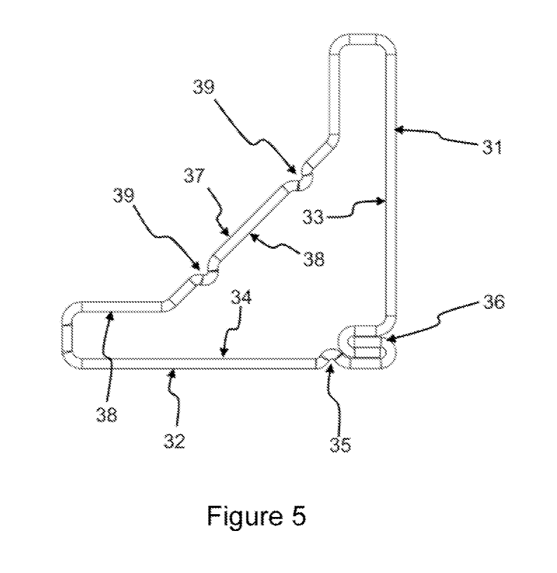

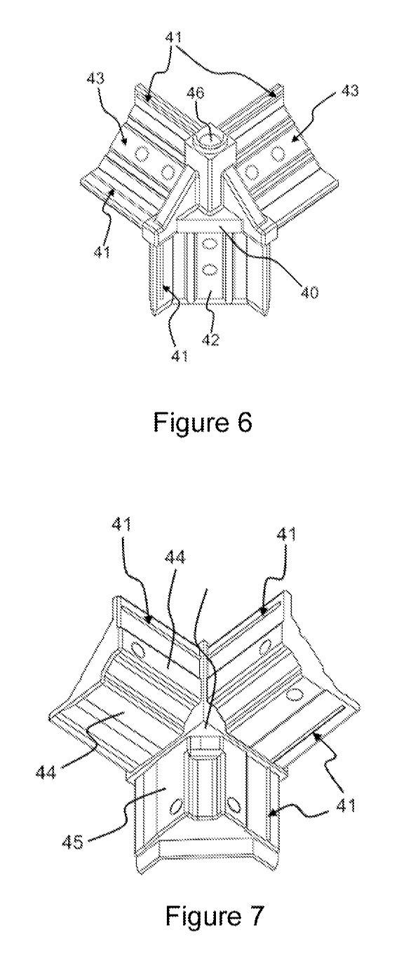

Coupling curve (36) is found in the place where rear exterior surfaces (31) and lower exterior surfaces (32) of the vertical profile (10) and of horizontal profiles (20) meet (FIG. 5). On any one of said exterior surfaces (31, 32), preferably on the lower exterior surface (32) on the other hand, there exists coupling indent (35) located in a way contacting with the coupling curve (36). The function of the coupling indent (35) is to increase resistance of the profiles (10, 20) forming the construction and prevent opening of the coupling curve (36).

1. A corner assembling system that provides assembling of power distribution panels, boxes and rectangular frame construction profiles with one another without a welding, comprising a vertical profile and horizontal profiles; coupling curve created on the vertical profile and horizontal profiles and assembling vertical profile and horizontal profiles without a welding, aluminium corner assembling member, and it is characterised in that it comprises:
at least one coupling indent created on a rear exterior surface or a lower exterior surface of the vertical profile and of horizontal profiles, ensuring not opening of said coupling curve;
at least one exterior surface support indent created on the front exterior surface OF the vertical profile and of horizontal profiles, providing resistance and support to the front exterior surface; and
a grounding tab created on the horizontal profile interior connection surface and on the horizontal profile exterior connection surface of the aluminium corner assembling member, increasing the grounding integrity of said aluminium corner assembling member.

2. Corner assembling system according to claim 1, and it is characterised in that it comprises:
a vertical profile interior tightening and connecting piece fixing the vertical profile to the aluminium corner assembling member from inside; and
a horizontal profile interior tighening and connecting piece fixing the horizontal profiles to both aluminium corner assembling member and to one another from inside.

3. Corner assembling system according to claim 2, and it is characterised in that it comprises:
anti flex heights created on said horizontal profile interior tightening and connecting pieces and not allowing flexibility of the horizontal profiles by engaging into the holes located on the rear exterior surface of the horizontal profiles.

4. Corner assembling system according to claims 2, and it is characterised in that it comprises:
support height providing said vertical profile interior tightening and connecting piece from spinning and providing the vertical profile to be supported.
